(19) United States
(12) Patent Application Publication
(10) Pub. No.: US 2016/0012251 A1
(43) Pub. Date: Jan. 14, 2016

(54) DISTRIBUTION, TRACKING, MANAGEMENT, REPORTING AND DEPLOYMENT OF CLOUD RESOURCES WITHIN AN ENTERPRISE

(71) Applicant: Anil Singh, Princeton, NJ (US)

(72) Inventor: Anil Singh, Princeton, NJ (US)

(21) Appl. No.: 14/327,571

(22) Filed: Jul. 10, 2014

(51) Int. Cl. G06F 21/62; H04L 29/06

(52) U.S. Cl. CPC G06F 21/6254; G06F 21/6227; H04L 63/102

(57) ABSTRACT

A cloud services management system (CMS) provides functional modules to help businesses manage cloud services by identifying users, business units and projects and assign levels of access to cloud services to each. Data pertaining to the foregoing is stored in a database. Using the CMS, an enterprise manages user privileges, distributes and reassigns modules to enable controlled distribution and re-assignment of cloud resources across an enterprise, monitors the consumption of cloud resources by an enterprise, geography, business unit, project and user, and provisions resources with time limits.

### FIELD OF THE INVENTION

This invention relates generally to cloud computing, and, more particularly, to a system and method for managing cloud services in an enterprise.

### BACKGROUND

Cloud computing providers offer services according to several fundamental models, including, but not limited to, infrastructure as a service (IaaS), platform as a service (PaaS), and software as a service (SaaS). Providers of IaaS offer computer resources, typically as virtual machines, and related resources. A virtual machine monitor (aka hypervisor) is a piece of computer software, firmware or hardware that creates and runs the virtual machines. IaaS clouds often offer related resources such as a virtual-machine disk image library, raw (block) and file-based storage, firewalls, load balancers, IP addresses, virtual local area networks (VLANs), and software bundles. For wide-area connectivity, customers can use either the Internet or dedicated virtual private networks.

In PaaS models, cloud providers deliver a computing platform (e.g., Windows Azure PaaS), typically including operating system, programming language execution environment, database, and web server. Application developers can develop and run their software solutions on a cloud platform, thereby avoiding the cost and complexity of buying and managing the underlying hardware and software layers.

In SaaS models, users are provided access to application software and databases. Cloud providers manage the infrastructure and platforms that run the applications. SaaS is sometimes referred to as “on-demand software” and is usually priced on a pay-per-use basis. SaaS providers generally price applications using a subscription fee.

Microsoft Corporation's Windows Azure® is a cloud computing platform and infrastructure for building, deploying and managing applications and services through a global network of Microsoft-managed data centers. It provides both PaaS and IaaS services and supports many different programming languages, tools and frameworks, including both Microsoft-specific and third-party software and systems.

While such services provide many advantages to companies, including reduced costs for IT hardware and software, they create new management issues. Among the new challenges, businesses have great difficulty tracking the cloud services being used by their business units and allocating available services in a controlled manner, and assigning costs for such services to responsible business units. Tools to efficiently manage cloud services, heretofore, have not been available. In addition, a self-service portal for project teams to request cloud services is not available, but needed.

The invention is directed to overcoming one or more of the problems and solving one or more of the needs as set forth above.

### SUMMARY OF THE INVENTION

To solve one or more of the problems set forth above, in an exemplary implementation of the invention, a computer implemented system and method are provided for managing cloud resources provided by a service provider computing system to a user computing device via a computer network. An exemplary cloud services management system (CMS) according to principles of the invention provides functional modules and processing steps to help businesses manage cloud services by identifying users, business units and projects and assign levels of access to cloud services to each. Data pertaining to the foregoing is stored in a database. Using the CMS, an enterprise manages user privileges, distributes and reassigns modules to enable controlled distribution and re-assignment of cloud resources across an enterprise, monitors the consumption of cloud resources by an enterprise, geography, business unit, project and user, and provisions resources with time limits.

A client tool is provided on a user computing device. The client tool comprises executable software, e.g., as an add-on to a browser, interface or other application used to access cloud services.

A management server in network communication with the client tool comprises a computing system communicatively coupled to the client tool. The management server may be a single computer server or a distributed system accessible by network.

A database is addressable by the management server. The database is stored on a mass storage device and includes a stored end user identification and a stored cloud resource identification associated with the stored end user identification.

The management server receives usage and consumption data from the service provider computing system via an interface. The service provider computing system tracks usage and consumption data for purposes of billing. The management server uses the data for managing the allocation of services.

The client tool intercepts a first request from the user computing device to the service provider computing system. The client tool sends the intercepted first request to the management server via network communication. The intercepted first request includes a first user identification and a first cloud resource identification. The management server retrieves from the database the stored end user identification and stored cloud resource identification. The management server determines if the stored end user identification is the same as the first user identification in the intercepted first request. The management server also determines if the stored cloud resource identification is the same as the first cloud resource identification in the intercepted first request.

If the management server determines that the stored end user identification is the same as the first user identification and the stored cloud resource identification is the same as the first cloud resource identification in the intercepted first request, then the management server sends an access granted reply to the client tool. If the management server determines that the stored end user identification is not the same as the first user identification, then the management server sends an access denied reply to the client tool. If the management server determines that the stored cloud resource identification is not the same as the first cloud resource identification in the intercepted first request, then the management server sends an access denied reply to the client tool. If the client tool receives an access granted reply from the management server in response to the first request, then the first client tool allowing the user computing device to send the first request to the service provider computer system. If the client tool receives an access denied reply from the management server in response to the first request, then the first client tool preventing the user computing device from sending the first request to the service provider computer system.

A plurality of stored business unit and/or project identifications may be stored in the database and associating with the stored user identification. The management server may determine if the at least one stored business unit identification is associated with the stored cloud resource identification. If the management server determines that the stored end user identification is the same as the first user identification and the stored cloud resource identification is the same as the first cloud resource identification in the intercepted first request, and the at least one stored business unit identification is associated with the stored cloud resource identification, then the management server sends an access granted reply to the client tool. If the management server determines that the stored end user identification is not the same as the first user identification, then the management server sends an access denied reply to the client tool. If the management server determines that the stored cloud resource identification is not the same as the first cloud resource identification in the intercepted first request, then the management server sends an access denied reply to the client tool. If the management server determines that the stored cloud resource identification is not associated with the at least one stored business unit identification, then the management server sends an access denied reply to the client tool. If the client tool receives an access granted reply from the management server in response to the first request, then the first client tool allowing the user computing device to send the first request to the service provider computer system. If the client tool receives an access denied reply from the management server in response to the first request, then the first client tool preventing the user computing device from sending the first request to the service provider computer system.

A plurality of stored temporal limits may be stored in the database. At least one of the stored temporal limits may be associated with the stored user identification or an associated project or business unit. If the management server determines that the stored end user identification is the same as the first user identification and the stored cloud resource identification is the same as the first cloud resource identification in the intercepted first request, and the at least one stored temporal limit is associated with the stored cloud resource identification, and the determined time is within the temporal limit, then the management server sends an access granted reply to the client tool. If the management server determines that the determined time is not within the at least one stored temporal limit, then the management server sends an access denied reply to the client tool. A temporal limit may be a time range from a start date and start time to an end date and end time, a time duration, or a recurring time range.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a high level block diagram conceptually illustrating exemplary components and network connections for a cloud services management system according to principles of the invention; and

FIG. 2 is a high level flowchart conceptually illustrating an exemplary user setup process for a cloud services management system according to principles of the invention; and

FIG. 3 is a high level flowchart conceptually illustrating an exemplary cloud resource unit definition process for a cloud services management system according to principles of the invention; and

FIG. 4 is a high level flowchart conceptually illustrating a project and business unit definition process for a cloud services management system according to principles of the invention; and

FIG. 5 is a high level flowchart conceptually illustrating an exemplary time-bound provisioning process for cloud resources such as virtual machines for a cloud services management system according to principles of the invention; and

FIG. 6 is a high level flowchart conceptually illustrating an exemplary resource request process for a cloud services management system according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations or steps as shown in the figures.

### DETAILED DESCRIPTION

A cloud services interface application is software, usually supplied by a cloud services provider, that enables or facilitates user access to the cloud services. By way of example and not limitation, Microsoft® provides a web-based GUI for accessing Windows Azure cloud services.

An exemplary cloud services management system (CMS) according to principles of the invention adds functionality to a cloud services interface application. An exemplary CMS may be implemented as an add-on, such as a plug-in or extension, to either a cloud services interface application or to a web browser. Implemented as an extension add-on, the CMS tailors the core features of a cloud services interface application or a web browser by adding one or more functional modules. As used herein, a module is a combination of instructions, processes and objects to perform determined tasks, which may be contained in a single code component or distributed among a plurality of code components. Alternatively, a CMS, according to principles of the invention, may be integrated with a cloud services interface application or comprise a substitute cloud service interface application.

A CMS according to principles of the invention provides functional modules to help businesses manage cloud services. User input into a client computer is transformed by the client computer into manageable and trackable requests relating to access and use of cloud resources. The requests are routed to, managed and tracked by a server, communicatively coupled to the client computer by a network. The CMS provides functionality to enable an enterprise to identify users and assign levels of access, associate users to business units and projects, associate cloud resources to business units and projects. Data pertaining to the foregoing is stored in a database. Functional modules of the CMS include access controls to allow an enterprise to manage user privileges, distribution and reassignment modules to enable controlled distribution and re-assignment of cloud resources across an enterprise, a tracking module to monitor the consumption of cloud resources by enterprise, geography, business unit, project and user; and a time-bound provisioning module which allows an enterprise to impose date and time limitations on allocated cloud resources. These processing steps and modules, which comprise a CMS system and methodology according to principles of the invention, are described in greater detail below. [We also need to include the self-service aspect where project team members can log on and request cloud resources. Each request gets routed to the project administrator. Once approved, cloud service gets provisioned.

An enterprise, as used herein, refers to a business or group of businesses, which may comprise a corporate group, including a parent company, sister companies and subsidiary companies. An enterprise may be composed of multiple business units, each of which may be responsible for its own costs and profitability. As used herein a business unit is a profit center which focuses on one or more product offerings and market segments. Business units may have a discrete marketing plan, analysis of competition, and marketing campaign, even though they may be part of a larger business entity.

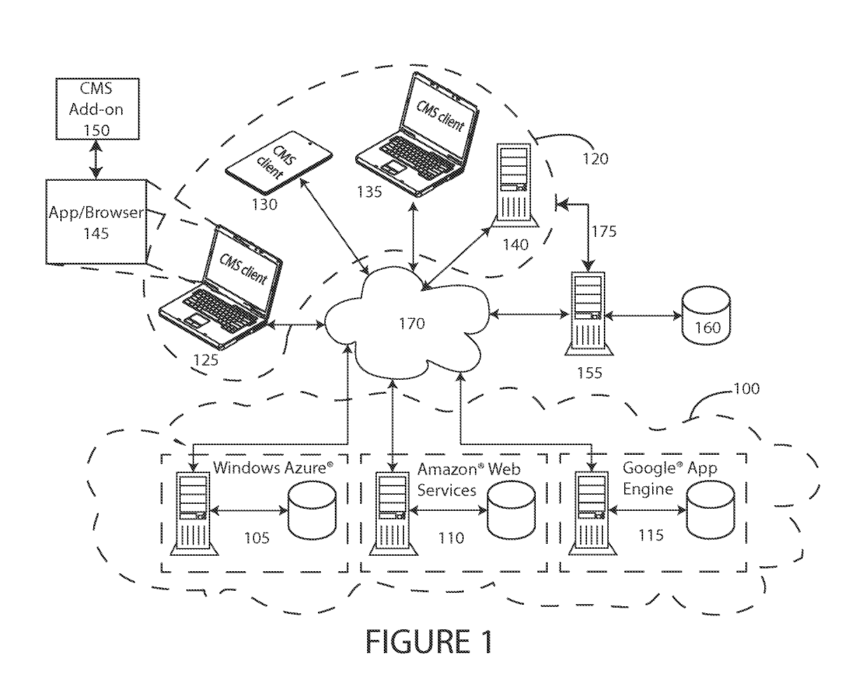

With reference to the high level block diagram of FIG. 1, cloud services 100 may include various applications provided by one or more computer hardware platforms such as, for example, a computer hardware platform providing Windows Azure® 105, a computer hardware platform providing Amazon® Web Services 110, and a computer hardware platform providing the Google® App Engine 115. While FIG. 1 illustrates three cloud services 100 computer hardware platforms 105-115, the invention is not limited to a particular cloud service or a computer hardware platform. The high level block diagram of FIG. 1 illustrates a single server for each cloud service platform, while in reality each platform may comprise a plurality of networked computer systems and data centers. The principles of the invention are not limited to any particular cloud services platform. As long as the cloud services are accessible through a browser or application that allows a CMS client as described herein, the principles of the invention may be applied.

Cloud services are accessed by users in an enterprise 120 via one or more computing devices 125-140. The computing devices may comprise servers, personal computers, laptop computers, hand held computers such as smart phones, or other computing device capable of executing a cloud services application, processing instructions and communicating data via a network. The computing devices access the cloud services via an application or browser 145 equipped with the CMS client 150.

A network accessible CMS server 155 stores data relating to the enterprise's cloud services allocation and usage in one or more databases 160 (i.e., a CMS database) on a mass storage device such as one or more computers, hard disks or nonvolatile random access memory modules. The CMS server 155 is a computer system (e.g., server computer), including a microprocessor, programmed and configured to manage the database 160 and perform the processing steps described herein in coordination with each CMS client 150. As used herein, database 160 refers collectively to a database and a database management system (DBMS) that stores, updates, sorts, searches and analyzes structured data in one or more databases, and produces reports based on the data. The database 160 comprises a key part of the CMS server 155. The CMS server 155 may be local to the enterprise and accessible via a private LAN 175, or remote from the enterprise, hosted by a third party and accessible via the Internet 170. The CMS client 150 operates in coordination with the CMS server 155. The CMS server 155 receives usage and consumption data from the service provider computing system 105 via an interface. The service provider computing system 105 tracks usage and consumption data for purposes of billing. The CMS server 155 uses the data for managing the allocation of services. Access and use restrictions are enforced via the CMS server 155 in coordination with the CMS client 150. Users are permitted to access and use only the cloud resources allocated to the user and only during times when cloud resources are active. The CMS client 150 provides to the CMS server 155 data regarding access and usage by the user using the computing device.

A CMS system 165 (i.e., CMS client 150 and CMS server 155 including CMS database 160) according to principles of the invention includes user setup and access control functionality, i.e., an access control module 205. The CMS client 150 operates in coordination with the CMS server 155 to provide access control. A user account is established by identifying a user and associating the user to one or more business units and/or projects. The business units and projects are defined in the database 160. User identifications are stored in the database 160. Business units and projects may be associated with a user. Thus, each user identification and associated business units and projects are stored in the database 160.

Access control allows a representative of an enterprise, i.e., one or more system administrators, to authorize and limit user access. Access authorization data is stored on the CMS server 155. Access to a cloud resource may be granted to an individual user, project members, a business unit or the entire enterprise.

The CMS client 150 communicates an access request to the CMS server 155, when a user attempts to access a cloud resource. The CMS system 165 then grants or rejects an access request from the user, based on what the user is authorized to access, as determined from the database 160. The CMS client 150 denies access to a cloud resource unless the CMS server 155 grants access. The CMS server 155 grants access only if a system administrator granted access to the user's account in the database 160. In this manner, user access may be limited to authorized allocated resources.

A CMS system 165 according to principles of the invention controls distribution e.g., via a distribution control module 210. The CMS client 150 operates in coordination with the CMS server 155 to control distribution. Distribution control determines the full range of available cloud resources for the enterprise according to the database. Distribution control also determines the resources that are currently allocated according to the database 160. Distribution control also determines the resources that are not currently allocated according to the database 160. Distribution control also allows allocation of resources. Resources are allocated when the resources are assigned for use by a user, a plurality of users, a business unit, project members, or the enterprise. A resource is assigned for use by a user, a plurality of users, a business unit, project members, or the enterprise by associating the resource with the user, each of the plurality of users, the business unit, the members of a project, or the enterprise, as the case may be, in the database 160. Using the distribution control module 210, a resource may be allocated to one or more users, business units, and projects.

A cloud resource is distributed by allocation. Allocation entails associating a resource with a user, a plurality of users, a business unit, a plurality of business units, project members, or the enterprise. The association is made in the database 160. Upon association, each user to which the resource has been allocated, or each user of a project team to which the resource has been allocated, or each user in a business unit to which the resource has been allocated, is authorized to access and use the resource. Thus, when such a user attempts to access the allocated resource, the CMS client 150 sends an access request to the CMS server 155. The access request identifies the user and the requested resource. Upon receiving an access request, the CMS server 155 determines if according to records of the database the user is authorized to access the requested resource. If the determination is affirmative, the server 155 grants access to the CMS client 150 by sending an affirmative response that identifies the user and the authorized resource. Unless the CMS client 150 receives such access in response to the access request, access to the resource is denied. If the CMS client 150 does not receive access in response to the access request within a determined time after a request, a message may be displayed indicating that the user lacks access and should contact the system administrator. If the determination is negative, the server 155 denies access to the CMS client 150 by sending a negative response that identifies the user and the denied resource. In such case, in response to the denial, the CMS client 150 prevents access to the resource and alerts the user accordingly. Access to a resource may be prevented by preventing or intercepting outbound requests for the resource from the CMS client 150 on the user's computing device 125-140 to the cloud service 100.

Requests and responses may, by way of example and not limitation, comprise HTTP messages. HTTP messages include requests from client (i.e., CMS client 150) to server (i.e., CMS server 155) and responses from server 155 to client 150. Request and response messages may use the same message format for transferring entities (i.e., the payload of the message). Both types of messages include a start-line, zero or more header fields (also known as “headers”), an empty line (i.e., a line with nothing preceding the CRLF) indicating the end of the header fields, and possibly a message-body. However, the invention is not limited to any particular message format. Message formats suitable for client-server communication other than HTTP messages may be utilized without departing from the scope of the invention.

Available resources may be manually entered as records in the CMS database 160 of the CMS system 165. Cloud resources may, for example, include virtual machine instances, network accessible storage and access to software and development tools including operating systems, compilers, databases. Each available resource may be divided into usable components. By way of example and not limitation, available storage space may be divided. Division of the resources is accomplished by defining the divided unit in an allocation database. Divided resources may then be allocated using the distribution control module 210.

A CMS system 165 according to principles of the invention allows imposition of temporal limitations on allocated resources. The CMS client 150 operates in coordination with the CMS server 155 to enforce time limitations, aka time-bound provisioning. Time-bound provisioning allows an enterprise to impose date and time limitations on allocated cloud resources. When a resource is allocated to a user, business unit, or project team, a range of times, such as a start and end time, may be specified and associated with the resource as allocated. Thus, an authorized user may access the allocated resource only during the provisioned time range. The time range may comprise a range of times from a start time to an end time, which may be recurring, such as daily, weekly, biweekly, monthly, bimonthly, or the like. Each time in the time range may includes a date and time of day, such as according to the following format: YYYY-MM-DDThh:mmTZD (eg 2013-07-16T19:20+01:00), where YYYY=four-digit year, MM=two-digit month (01=January, etc.), DD=two-digit day of month (01 through 31), hh=two digits of hour (00 through 23), mm=two digits of minute (00 through 59), TZD=time zone designator (Z or +hh:mm or −hh:mm). Other time formats may be used without departing from the scope of the invention. Dates may be set using a calendar control. Time may be specified using a time control such as a digital clock with user selectable hours, minutes and seconds.

In another embodiment, the temporal limitation may comprise a cumulative duration. For example, a business unit may be allocated X hours of a resource. The duration may be specified in hours, minutes, seconds and even a decimal fraction of a second. Additionally, the duration limit may be imposed during a provisioned time range. Thus, for example, a business unit may be allocated a total of X hours of a resource to be used between a start date and an end date. Additionally, a resource may be allocated to another user, business unit or team after expiration of a temporal or duration limit.

When a user attempts to access the allocated resource, the CMS client 150 sends an access request to the CMS server 155. The access request identifies the user and the requested resource. Upon receiving an access request, the CMS server 155 determines if according to records of the database the user is authorized to access the requested resource. If the determination is affirmative and there is no temporal limitation associated with the allocated resource, the server 155 grants access to the CMS client 150 by sending an affirmative response that identifies the user and the authorized resource. If a temporal limitation is associated with the allocated resource in the database 160, then a determination is made if the access is within the bounds of the temporal limitation. For a duration limit, the cumulative total access time is compared with the limit at the time the request is made. If the cumulative total access time is less than the limit, then access is granted. Otherwise access is denied. For a time range limit, the time (i.e., date and time) at the time of the request is compared with the allowable dates and times. If the then-current time is an allowable time, then access is granted. Otherwise access is denied. Unless the CMS client 150 receives such access in response to the access request, access to the resource is denied. If the CMS client 150 does not receive access in response to the access request within a determined time after a request, a message may be displayed indicating that the user lacks access and should contact the system administrator. If the determination is negative, the server 155 denies access to the CMS client 150 by sending a negative response that identifies the user and the denied resource. In such case, in response to the denial, the CMS client 150 prevents access to the resource and alerts the user accordingly. Access to a resource may be prevented by preventing or intercepting outbound requests for the resource from the CMS client 150 on the user's computing device 125-140 to the cloud service 100.

Each user session is tracked by the service provider's system 105. The user's identification, start and end time for a session, and cloud resources used during a session, are all tracked by the service provider's system 105 for purposes of billing. Such data is made available to the CMS server 150 via an interface with the service provider's system 105. The CMS server 150 receives usage and consumption data from the service provider's system 105 via an interface. The CMS server 150 uses the data for managing the allocation of services, including enforcement of limits.

The CMS system 165 defines usage and consumption limits for business units, projects and users. By comparing usage and consumption data with limits, the CMS system 165 can determine if a limit has been exceeded.

Reports summarize and present data from the CMS database 160 in data tables. Reports may present resources allocated to and consumed by users, projects, business units and the enterprise. Reports may present all cloud resources allocated, consumed, unallocated, total, by day, week, month or other period of time. Reports may present other data available in the database 160. Reports may be customized. A report may be generated at any time, and will always reflect the current data in the database. Reports may be formatted to be printed out, but they can also be viewed on the screen, exported to another program, or sent as e-mail message.

Queries, e.g., select queries and action queries, retrieve specific data from tables comprising the database 160. Data desired for analysis may be spread across several tables. Queries allow viewing specific data in a single datasheet. Also, to limit the records presented, queries allow filtering the data down to just the records of interest. Queries may serve as the record source for forms and reports. Queries also allow performing tasks with the data. As a non-limiting example, queries may be used to determine when cloud resource consumption exceeds a threshold or is approaching a limit. Queries may facilitate tracking consumption of cloud resources by country, business unit, project and/or user.

The CMS system 165 generates alerts when a business unit or project's consumption of cloud resources approaches an allocated quota (i.e., limit). For example—when a business unit's consumption reaches 80% of an allocated quota, an administrator may be notified through email or text message. The notification threshhold (e.g., 75%, or 80%, or 85%, or some other threshhold) may be set by an administrator. Such early notification is optional, but deemed advisable to facilitate management of cloud resources.

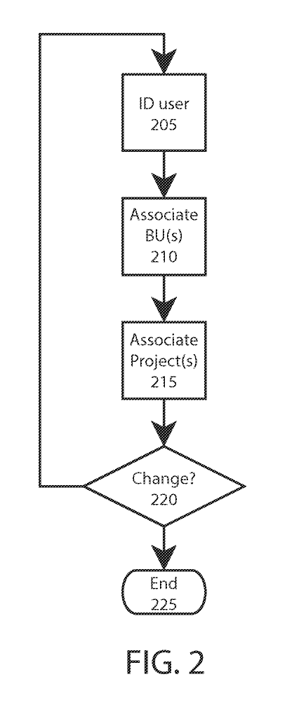

Referring to FIG. 2, a high level flowchart conceptually illustrating an exemplary user setup process for a cloud services management system according to principles of the invention is provided. In step 205, a user may be identified in the system using any form of user identification, such as a name, email address or code. One or more records are created for each user to associate the user with one or more business units and projects, as in steps 210 and 215. A user may be associated none, one or more than one business units and projects. Identifications and associations may be changed as necessary, as in step 220. If no changes are necessary, the process is completed for a user, as in step 225. The process may be performed for each user.

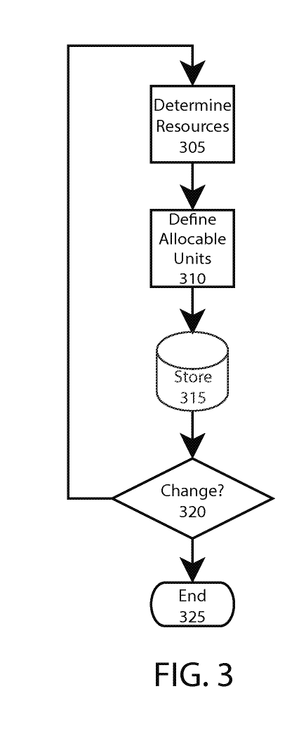

FIG. 3 provides a high level flowchart conceptually illustrating an exemplary cloud resource unit definition process for a cloud services management system according to principles of the invention. The process entails determining cloud resources available to users of an enterprise, as in step 305. This information may be supplied from the cloud service provider or manually entered. For example, storage space may be allocated in units of X Gbytes. Allocable units may then be defined, as in step 310. This data is stored in the CMS database 160, as in step 315. The available units of cloud resources may then be allocated to users, projects and business units. Changes may be made, as in step 320. The process terminates if no changes are needed, as in step 325. The process may be repeated as necessary.

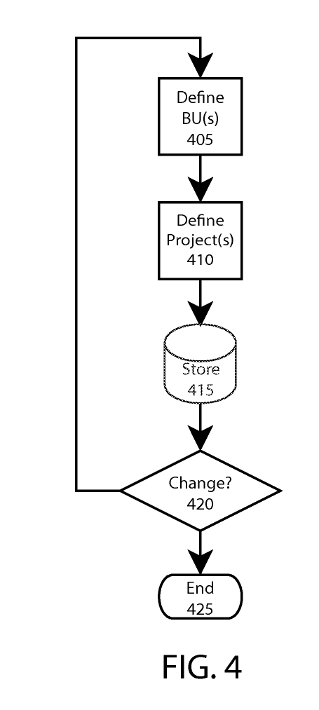

FIG. 4 is a high level flowchart conceptually illustrating a project and business unit definition process for a cloud services management system according to principles of the invention. The allocable units of cloud services defined in the process described with reference to FIG. 3 may be associated with business units and projects. The process in FIG. 4 defines such projects and processes, in either order, as in steps 405 and 410. The projects and business units are stored as records in the CMS database 160, as in step 415. Changes may be made, as in step 420. The process terminates if no changes are needed, as in step 425. The process may be repeated as necessary.

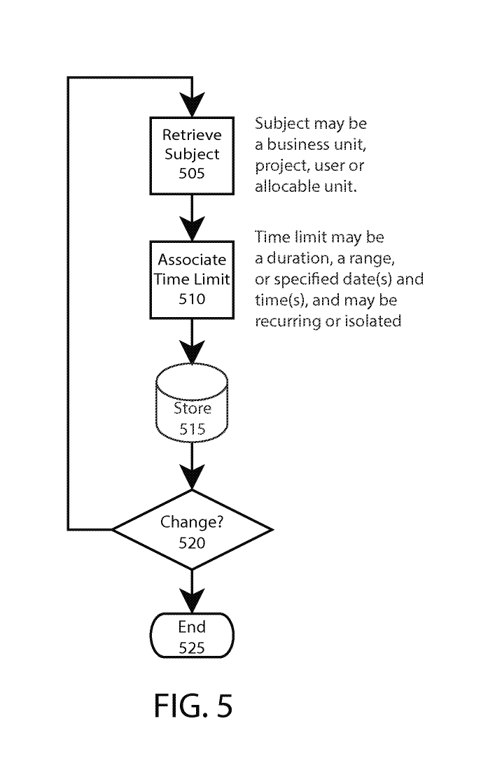

FIG. 5 is a high level flowchart conceptually illustrating an exemplary time-bound provisioning process for a cloud services management system according to principles of the invention. A subject may be a business, unit, project, user, cloud resource or allocable unit, as in step 505. A time limit may be set for any of the foregoing subject matter, as in 510. The time limit may be a specific date, a specific date and time, a range of dates and/or times, recurring days and/or times of day, or a cumulative total time duration, or combinations or variations of the foregoing. A time limit may be set for a subject using a calendar and or clock control to select dates and times. The type of time limit, date, range, recurrence, cumulative total and the like may be selected from other user interface controls. The time limit details and corresponding subject are stored in the CMS database 160, as in step 515. Changes may be made, as in step 520. The process terminates if no changes are needed, as in step 525. The process may be repeated as necessary.

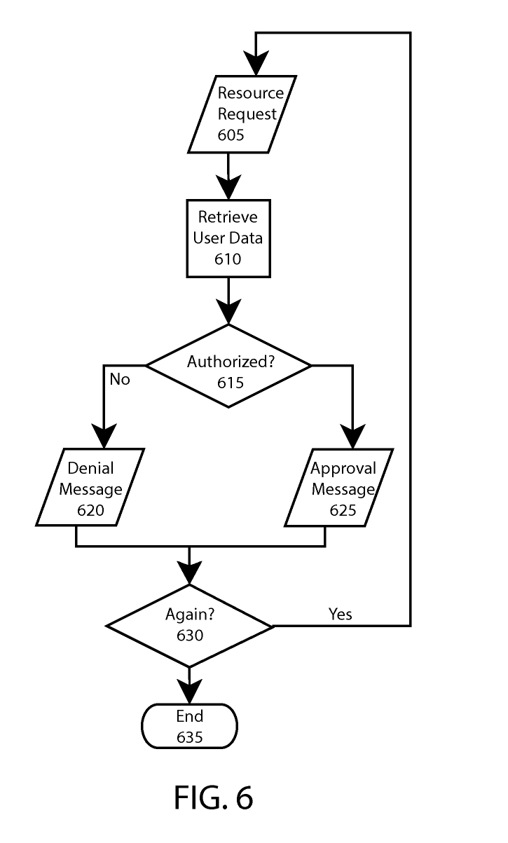

FIG. 6 is a high level flowchart conceptually illustrating an exemplary resource request process for a cloud services management system according to principles of the invention. The CMS client 150 communicates a resource request from a user's computing device to the CMS server 155. When the CMS server 155 receives the request, as in step 605, the CMS server 155 retrieves the user's data for the request from the database 160, as in step 610. The user data will indicate which resources the user may access. Such data may include information regarding resources specifically allocated to the user, projects and business units to which the user is assigned and their allocated resources, and any time-bounds provisioned in accordance with the process of FIG. 5. If the user is not authorized to access the resource or the current time is not within the provisioned time limit, then a denial message is sent from the CMS server 155 to the CMS client 150, as in step 620. If the User is authorized to access the resource and there is no time limit, or the current time is within the provisioned time limit, then an approval message is sent from the CMS server 155 to the CMS client 150, as in step 625. The process may be repeated as in step 630. The process ends when there are no further resource requests, as in step 635. The CMS client 150 allows access to a resource only to the extent approved by the CMS server 155 or an administrator, as communicated in an approval message.

The CMS client 150 in coordination with the CMS server 155 enable tracking and reporting. Access to and use of cloud resources is tracked, meaning that information regarding each session of use of cloud services through the CMS client 150 is tracked by the service provider's system 105-115 and made available to the CMS server 155 for storage in the database 160. The end user, any associated business unit and project, are tracked with each end user session. The start and end time of each session is tracked. The cloud resources consumed during a session are tracked. The tracked information is conveyed from the service provider's system 105-115 to the CMS server 155, where it is associated with business units, projects and users and stored in the database 160. The tracked information may then be used for queries and to generate reports from the database. Reports may show the cloud resources available, allocated and consumed by end user, business unit, project enterprise, or other definable category.

A self service portal enables users to submit requests for cloud services (e.g., provisioning requests) via the CMS client 150. Provisioning requests are sent from the CMS client 150 to the CMS server 155. In one embodiment, a party with administrative privileges may be notified of the provisioning request to grant or deny the request on an ad hoc basis or according to established rules. In another embodiment, a provisioning request may be automatically processed by approving or denying a request according to pre-defined rules. By way of example, the CMS server 155 may parse and process provisioning requests. Processing may entail comparing the request with established provisioning rules. In this manner the CMS server 155 may grant or deny provisioning requests. Illustratively, the CMS server 155 may grant a request for a requested cloud service and/or up to a determined limit. Optionally, prior to an automatic denial, an administrator may be notified to personally consider and grant or deny the request. When a request is granted, the CMS database 160 is updated to reflect the newly provisioned resource, allocating it to a business unit, project and users.

A provisioning request may comprise a packet containing control information and a payload. The control information provides data the network needs to deliver the user data, for example: source and destination network addresses, error detection codes, and sequencing information. The control information may be found in a packet header and/or trailer, with payload data being between the header and trailer. The header and/or payload may contain the following: identification of a business unit, identification of a project, identification of a user, identification of a cloud resource, quantitative information, and temporal information. The quantitative information specifies a quantity of the cloud resource required. For example, the quantity may comprise a storage space in Gbytes, or a bandwidth in bit/s, kbit/s, Mbit/s, Gbit/s, etc., or a quantity of resources such as virtual machines. The temporal information may comprise dates and times needed. The CMS client 150 may provide a form to generate and transmit the request.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A computer implemented method of managing cloud resources provided by a service provider computing system to a user computing device via a computer network, said method comprising steps of:
providing a client tool on the user computing device, said client tool comprising executable software, said computing device including a user input device,
providing a management server in network communication with the client tool, said management server comprising a computing system communicatively coupled to the client tool,
providing a database addressable by the management server, the database being stored on a mass storage device and including a stored end user identification and a stored cloud resource identification associated with the stored end user identification,
the client tool intercepting a first request from the user computing device to the service provider computing system, said first request being generated from a first user input from a first user using the user input device,
the client tool sending the intercepted first request to the management server via network communication,
the intercepted first request including a first user identification and a first cloud resource identification,
the management server retrieving from the database the stored end user identification and stored cloud resource identification,
the management server determining if the stored end user identification is the same as the first user identification in the intercepted first request,
the management server determining if the stored cloud resource identification is the same as the first cloud resource identification in the intercepted first request,
if the management server determines that the stored end user identification is the same as the first user identification and the stored cloud resource identification is the same as the first cloud resource identification in the intercepted first request, then the management server sends an access granted reply to the client tool, and
if the management server determines that the stored end user identification is not the same as the first user identification, then the management server sends an access denied reply to the client tool,
if the management server determines that the stored cloud resource identification is not the same as the first cloud resource identification in the intercepted first request, then the management server sends an access denied reply to the client tool,
if the client tool receives an access granted reply from the management server in response to the first request, then the first client tool allows the user computing device to send the first request to the service provider computer system, and
if the client tool receives an access denied reply from the management server in response to the first request, then the first client tool preventing the user computing device from sending the first request to the service provider computer system.

2. The computer implemented method of claim 1, further comprising steps of
storing in the database a plurality of stored business unit identifications,
associating at least one stored business unit identification with the stored user identification,
the management server retrieving from the database the stored end user identification and stored cloud resource identification, and the at least one stored business unit identification,
the management server determining if the stored end user identification is the same as the first user identification in the intercepted first request,
the management server determining if the stored cloud resource identification is the same as the first cloud resource identification in the intercepted first request,
the management server determining if the at least one stored business unit identification is associated with the stored cloud resource identification;
if the management server determines that the stored end user identification is the same as the first user identification and the stored cloud resource identification is the same as the first cloud resource identification in the intercepted first request, and the at least one stored business unit identification is associated with the stored cloud resource identification, then the management server sends an access granted reply to the client tool, and
if the management server determines that the stored end user identification is not the same as the first user identification, then the management server sends an access denied reply to the client tool,
if the management server determines that the stored cloud resource identification is not the same as the first cloud resource identification in the intercepted first request, then the management server sends an access denied reply to the client tool,
if the management server determines that the stored cloud resource identification is not associated with the at least one stored business unit identification, then the management server sends an access denied reply to the client tool,
if the client tool receives an access granted reply from the management server in response to the first request, then the first client tool allowing the user computing device to send the first request to the service provider computer system, and
if the client tool receives an access denied reply from the management server in response to the first request, then the first client tool preventing the user computing device from sending the first request to the service provider computer system.

3. The computer implemented method of claim 1, further comprising steps of
storing in the database a plurality of stored project identifications,
associating at least one stored project identification with the stored user identification,
the management server retrieving from the database the stored end user identification and stored cloud resource identification, and the at least one stored project identification,
the management server determining if the stored end user identification is the same as the first user identification in the intercepted first request,
the management server determining if the stored cloud resource identification is the same as the first cloud resource identification in the intercepted first request,
the management server determining if the at least one stored project identification is associated with the stored cloud resource identification;
if the management server determines that the stored end user identification is the same as the first user identification and the stored cloud resource identification is the same as the first cloud resource identification in the intercepted first request, and the at least one stored project identification is associated with the stored cloud resource identification, then the management server sends an access granted reply to the client tool, and
if the management server determines that the stored end user identification is not the same as the first user identification, then the management server sends an access denied reply to the client tool,
if the management server determines that the stored cloud resource identification is not the same as the first cloud resource identification in the intercepted first request, then the management server sends an access denied reply to the client tool,
if the management server determines that the stored cloud resource identification is not associated with the at least one stored project identification, then the management server sends an access denied reply to the client tool,
if the client tool receives an access granted reply from the management server in response to the first request, then the first client tool allowing the user computing device to send the first request to the service provider computer system, and
if the client tool receives an access denied reply from the management server in response to the first request, then the first client tool preventing the user computing device from sending the first request to the service provider computer system.

4. The computer implemented method of claim 2, further comprising steps of
storing in the database a plurality of stored project identifications,
associating at least one stored project identification with the stored user identification,
the management server retrieving from the database the stored end user identification and stored cloud resource identification, and the at least one stored project identification,
the management server determining if the stored end user identification is the same as the first user identification in the intercepted first request,
the management server determining if the stored cloud resource identification is the same as the first cloud resource identification in the intercepted first request,
the management server determining if the at least one stored project identification is associated with the stored cloud resource identification;
if the management server determines that the stored end user identification is the same as the first user identification and the stored cloud resource identification is the same as the first cloud resource identification in the intercepted first request, and the at least one stored project identification is associated with the stored cloud resource identification, then the management server sends an access granted reply to the client tool, and
if the management server determines that the stored end user identification is not the same as the first user identification, then the management server sends an access denied reply to the client tool,
if the management server determines that the stored cloud resource identification is not the same as the first cloud resource identification in the intercepted first request, then the management server sends an access denied reply to the client tool,
if the management server determines that the stored cloud resource identification is not associated with the at least one stored project identification, then the management server sends an access denied reply to the client tool,
if the client tool receives an access granted reply from the management server in response to the first request, then the first client tool allowing the user computing device to send the first request to the service provider computer system, and
if the client tool receives an access denied reply from the management server in response to the first request, then the first client tool preventing the user computing device from sending the first request to the service provider computer system.

5. The computer implemented method of claim 1, further comprising steps of
storing in the database a plurality of stored temporal limits,
associating at least one stored temporal limit with the stored user identification,
the management server retrieving from the database the stored end user identification and stored cloud resource identification, and the at least one stored temporal limit,
the management server determining if the stored end user identification is the same as the first user identification in the intercepted first request,
the management server determining if the stored cloud resource identification is the same as the first cloud resource identification in the intercepted first request,
the management server determining if the at least one stored temporal limit is associated with the stored cloud resource identification;
the management server determining a time;
if the management server determines that the stored end user identification is the same as the first user identification and the stored cloud resource identification is the same as the first cloud resource identification in the intercepted first request, and the at least one stored temporal limit is associated with the stored cloud resource identification, and the determined time is within the temporal limit, then the management server sends an access granted reply to the client tool, and
if the management server determines that the stored end user identification is not the same as the first user identification, then the management server sends an access denied reply to the client tool,
if the management server determines that the stored cloud resource identification is not the same as the first cloud resource identification in the intercepted first request, then the management server sends an access denied reply to the client tool,
if the management server determines that the determined time is not within the at least one stored temporal limit, then the management server sends an access denied reply to the client tool,
if the client tool receives an access granted reply from the management server in response to the first request, then the first client tool allowing the user computing device to send the first request to the service provider computer system, and
if the client tool receives an access denied reply from the management server in response to the first request, then the first client tool preventing the user computing device from sending the first request to the service provider computer system.

6. The computer implemented method of claim 5, the at least one temporal limit comprising a time range from a start date and start time to an end date and end time.

7. The computer implemented method of claim 5, the at least one temporal limit comprising time duration.

8. The computer implemented method of claim 5, the at least one temporal limit comprising a recurring time range.

9. The computer implemented method of claim 1, further comprising a step of storing session information on the database, said session information including the first user identification, the first cloud resource identification, a session start time, a session start date, a session end time, and a session end date.

10. The computer implemented method of claim 1, further comprising a step of reporting session information.

11. A system for managing cloud resources provided by a service provider computing system to a user computing device via a computer network, said system comprising:
a client tool on the user computing device, said client tool comprising executable software,
a management server in network communication with the client tool, said management server comprising a computing system communicatively coupled to the client tool,
a database addressable by the management server, the database being stored on a mass storage device and including a stored end user identification and a stored cloud resource identification associated with the stored end user identification,
the client tool intercepting a first request from the user computing device to the service provider computing system,
the client tool sending the intercepted first request to the management server via network communication,
the intercepted first request including a first user identification and a first cloud resource identification,
the management server retrieving from the database the stored end user identification and stored cloud resource identification,
the management server determining if the stored end user identification is the same as the first user identification in the intercepted first request,
the management server determining if the stored cloud resource identification is the same as the first cloud resource identification in the intercepted first request,
if the management server determines that the stored end user identification is the same as the first user identification and the stored cloud resource identification is the same as the first cloud resource identification in the intercepted first request, then the management server sends an access granted reply to the client tool, and
if the management server determines that the stored end user identification is not the same as the first user identification, then the management server sends an access denied reply to the client tool,
if the management server determines that the stored cloud resource identification is not the same as the first cloud resource identification in the intercepted first request, then the management server sends an access denied reply to the client tool,
if the client tool receives an access granted reply from the management server in response to the first request, then the first client tool allowing the user computing device to send the first request to the service provider computer system, and
if the client tool receives an access denied reply from the management server in response to the first request, then the first client tool preventing the user computing device from sending the first request to the service provider computer system.

12. The computer system of claim 11, further comprising:
the database storing a plurality of stored business unit identifications,
the database associating at least one stored business unit identification with the stored user identification,
the management server retrieving from the database the stored end user identification and stored cloud resource identification, and the at least one stored business unit identification,
the management server determining if the stored end user identification is the same as the first user identification in the intercepted first request,
the management server determining if the stored cloud resource identification is the same as the first cloud resource identification in the intercepted first request,
the management server determining if the at least one stored business unit identification is associated with the stored cloud resource identification;
if the management server determines that the stored end user identification is the same as the first user identification and the stored cloud resource identification is the same as the first cloud resource identification in the intercepted first request, and the at least one stored business unit identification is associated with the stored cloud resource identification, then the management server sends an access granted reply to the client tool, and
if the management server determines that the stored end user identification is not the same as the first user identification, then the management server sends an access denied reply to the client tool,
if the management server determines that the stored cloud resource identification is not the same as the first cloud resource identification in the intercepted first request, then the management server sends an access denied reply to the client tool,
if the management server determines that the stored cloud resource identification is not associated with the at least one stored business unit identification, then the management server sends an access denied reply to the client tool,
if the client tool receives an access granted reply from the management server in response to the first request, then the first client tool allowing the user computing device to send the first request to the service provider computer system, and
if the client tool receives an access denied reply from the management server in response to the first request, then the first client tool preventing the user computing device from sending the first request to the service provider computer system.

13. The computer system of claim 11, further comprising
the database storing a plurality of stored project identifications,
the database associating at least one stored project identification with the stored user identification,
the management server retrieving from the database the stored end user identification and stored cloud resource identification, and the at least one stored project identification,
the management server determining if the stored end user identification is the same as the first user identification in the intercepted first request,
the management server determining if the stored cloud resource identification is the same as the first cloud resource identification in the intercepted first request,
the management server determining if the at least one stored project identification is associated with the stored cloud resource identification;
if the management server determines that the stored end user identification is the same as the first user identification and the stored cloud resource identification is the same as the first cloud resource identification in the intercepted first request, and the at least one stored project identification is associated with the stored cloud resource identification, then the management server sends an access granted reply to the client tool, and
if the management server determines that the stored end user identification is not the same as the first user identification, then the management server sends an access denied reply to the client tool,
if the management server determines that the stored cloud resource identification is not the same as the first cloud resource identification in the intercepted first request, then the management server sends an access denied reply to the client tool,
if the management server determines that the stored cloud resource identification is not associated with the at least one stored project identification, then the management server sends an access denied reply to the client tool,
if the client tool receives an access granted reply from the management server in response to the first request, then the first client tool allowing the user computing device to send the first request to the service provider computer system, and
if the client tool receives an access denied reply from the management server in response to the first request, then the first client tool preventing the user computing device from sending the first request to the service provider computer system.

14. The computer system of claim 12, further comprising steps of
the database storing a plurality of stored project identifications,
the database associating at least one stored project identification with the stored user identification,
the management server retrieving from the database the stored end user identification and stored cloud resource identification, and the at least one stored project identification,
the management server determining if the stored end user identification is the same as the first user identification in the intercepted first request,
the management server determining if the stored cloud resource identification is the same as the first cloud resource identification in the intercepted first request,
the management server determining if the at least one stored project identification is associated with the stored cloud resource identification;
if the management server determines that the stored end user identification is the same as the first user identification and the stored cloud resource identification is the same as the first cloud resource identification in the intercepted first request, and the at least one stored project identification is associated with the stored cloud resource identification, then the management server sends an access granted reply to the client tool, and
if the management server determines that the stored end user identification is not the same as the first user identification, then the management server sends an access denied reply to the client tool,
if the management server determines that the stored cloud resource identification is not the same as the first cloud resource identification in the intercepted first request, then the management server sends an access denied reply to the client tool,
if the management server determines that the stored cloud resource identification is not associated with the at least one stored project identification, then the management server sends an access denied reply to the client tool,
if the client tool receives an access granted reply from the management server in response to the first request, then the first client tool allowing the user computing device to send the first request to the service provider computer system, and
if the client tool receives an access denied reply from the management server in response to the first request, then the first client tool preventing the user computing device from sending the first request to the service provider computer system.

15. The computer system of claim 11, further comprising
a plurality of stored temporal limits stored in the database,
the database associating at least one stored temporal limit with the stored user identification,
the management server retrieving from the database the stored end user identification and stored cloud resource identification, and the at least one stored temporal limit,
the management server determining if the stored end user identification is the same as the first user identification in the intercepted first request,
the management server determining if the stored cloud resource identification is the same as the first cloud resource identification in the intercepted first request,
the management server determining if the at least one stored temporal limit is associated with the stored cloud resource identification;
the management server determining a time;
if the management server determines that the stored end user identification is the same as the first user identification and the stored cloud resource identification is the same as the first cloud resource identification in the intercepted first request, and the at least one stored temporal limit is associated with the stored cloud resource identification, and the determined time is within the temporal limit, then the management server sends an access granted reply to the client tool, and
if the management server determines that the stored end user identification is not the same as the first user identification, then the management server sends an access denied reply to the client tool,
if the management server determines that the stored cloud resource identification is not the same as the first cloud resource identification in the intercepted first request, then the management server sends an access denied reply to the client tool,
if the management server determines that the determined time is not within the at least one stored temporal limit, then the management server sends an access denied reply to the client tool,
if the client tool receives an access granted reply from the management server in response to the first request, then the first client tool allowing the user computing device to send the first request to the service provider computer system, and
if the client tool receives an access denied reply from the management server in response to the first request, then the first client tool preventing the user computing device from sending the first request to the service provider computer system.

16. The computer system of claim 15, the at least one temporal limit comprising a time range from a start date and start time to an end date and end time.

17. The computer system of claim 15, the at least one temporal limit comprising time duration.

18. The computer system of claim 15, the at least one temporal limit comprising a recurring time range.

19. The computer system of claim 11, further comprising a step of storing session information on the database, said session information including the first user identification, the first cloud resource identification, a session start time, a session start date, a session end time, and a session end date.

20. The computer system of claim 11, further comprising a step of reporting session information.
